(19) United States
(12) Patent Application Publication
(10) Pub. No.: US 2006/0230695 A1
(43) Pub. Date: Oct. 19, 2006

(54) Window shutter system

(76) Inventor: Jon L. Swergold, Boynton Beach, FL (US)

Correspondence Address: RUDEN, MCCLOSKY, SMITH, SCHUSTER & RUSSELL, P.A., 222 LAKEVIEW AVE, SUITE 800, WEST PALM BEACH, FL, 33401-6112, US

(21) Appl. No.: 11/091,273

(22) Filed: Mar. 28, 2005

(51) Int. Cl. E06B 3/26

(52) U.S. Cl. 52/202

(57) ABSTRACT

A window shutter system having an escape hatch has been developed which is capable of protecting a building from adverse weather conditions while not blocking efficient egress from the building during an emergency such as a fire.

### FIELD OF THE INVENTION

The invention relates to devices and methods for protecting a building and its windows from adverse weather conditions. More particularly, the invention relates to a window shutter having a means for egress.

### BACKGROUND

Every year, millions of dollars in residential and commercial damages result from adverse weather conditions. High winds experienced during hurricanes, tornadoes, and typhoons put buildings such as houses at risk for damage from airborne debris. Heavy rain experienced with such storms puts houses at risk for flooding and water damage. Windows in particular are perhaps the most vulnerable part of a house during a powerful storm such as a hurricane.

A variety of options exist for protecting a window and its associated structure against storm winds, rains, and debris. Wooden shutters are often pivotally mounted adjacent to building windows and closed as necessary over the window glass to protect it from storm damage. Aluminum or steel panels that are installed in segments over windows are commonly used. Multiple-bladed rolling shutter systems, particularly those with automatic drive mechanisms, are installed by some homeowners over windows as a form of protection. Other homeowners nail plywood over their windows while others place various types of adhesive-backed tape directly onto window glass.

A drawback of currently used window shutters and related devices for protecting a building against the hazards of a powerful storm is that they are usually installed against the outside of the structure, thereby making it difficult if not impossible for a person inside the building to use the window as a means of egress during an emergency such as a fire. A window shutter which is capable of protecting a structure from adverse weather conditions while not blocking efficient egress from the home during emergencies is therefore highly desirable.

### SUMMARY OF THE INVENTION

The invention relates to a newly developed shutter system that includes an escape hatch which provides a means of egress for a person inside the building during an emergency, e.g., a house fire. A preferred variation of the shutter system includes multiple rigid panels. The shutter system of the invention should be sufficiently strong so as to sustain high-velocity winds, such as those of about 235 kilometers per hour (e.g., hurricane force winds) and comply with Miami-Dade County building codes (e.g., High Velocity Hurricane Zone section of the Florida Building Code, Section 6 of ASCE 7-98, etc.).

Accordingly, the invention features a shutter system for an openable window mounted in a building wall separating the interior and exterior of a building. The system includes (a) a plurality of panels capable of being assembled into an impact-resistant shutter (i) sized to cover at least most of the portion of the window facing the exterior of the building and (ii) including an aperture sized for a person to pass through, and (b) a means for reversibly attaching the plurality of panels to the wall, (c) an impact-resistant cover for the aperture, the cover being of sufficient size to close at least most of the aperture and reversibly postionable between a closed position wherein at least most of the aperture is covered and an open position wherein most of the aperture is not covered, and (d) at least one means for attaching the cover to the shutter.

The panels of the shutter system can have a variety of shapes. For example, the panels can be corrugated, such that the ridges of at least one panel of the plurality of panels overlaps with the ridges of at least a second panel of the plurality of panels when the at least one and at least second panels are placed in an overlapping position. The panels are preferably shaped such that they interlock with one another. In addition to being corrugated, the panels can be rectangular, square, polygonal, oval, elliptical, and circular.

The plurality of panels can be made from a variety of materials including metal, wood, plastic, and impact-resistant polymer. Examples of preferred materials include aluminum, aluminum alloy, polycarbonate, polyvinyl chloride, steel, and galvanized steel. The panels can be translucent or transparent. For resisting hurricane winds, the shutter system of the invention should be capable of resisting sustained winds in the range of about 60 kilometers per hour to about 240 kilometers per hours (e.g., 50.0, 60.0, 70.0, 80.0, 90.0, 100.0, 110.0, 120, 130, 140, 150, 160, 170, 180, 190, 200, 210, 220, 230, 240, 250 kilometers per hour).

The plurality of panels can have a variety of dimensions. The width of each panel, for example, can be in the range of about 0.2 meters (m) to about 0.5 m, e.g., 0.3 m, 0.33 m, 0.36 m, 0.4, 0.45, 0.5, 0.55, and 0.6. The height of each panel can be in the range of about 1 m to about 3.81 m, e.g., 1.1 m, 1.4 m, 1.7 m, 2.2 m, 3.7 m, etc. The thickness of each panel can be 0.8 millimeters (mm), 1 mm, 1.3 mm, 1.5 mm, 1.6 mm, 20 gauge, 22 gauge, 22 gauge, and 24 gauge, etc.

The aperture of the shutter system of the invention can have a variety of dimensions and shapes. The aperture has a surface area sufficiently large to allow an adult human to pass through, e.g., in the range of about 0.18 square meters to about 1.5 square meters. The aperture can have an edge, preferably an edge that is substantially blunt. The shutter system can also include a covering (e.g., material made from rubber, plastic, fabric, and metal) for disposing on the edge for providing an aperture free of sharp edges. In preferred embodiments, the aperture is positioned such that the window is openable when the shutter is positioned over the window.

The shutter system of the invention can further include a means for reversibly attaching the plurality of panels to the wall. Such a means can include a plurality of holes positioned on at least one side of each panel and a plurality of bolts for mating with the holes.

The impact-resistant cover of the shutter system of the invention is made from a material such as metal, wood, plastic, and impact-resistant polymer. Preferred materials include aluminum, aluminum alloy, polyvinyl chloride, polycarbonate, steel, and galvanized steel. In preferred embodiments, the panels and the impact-resistant cover are made from the same material. The impact-resistant cover can be translucent or transparent and can have a variety of shapes including rectangular, square, oval, elliptical, polygonal and circular. The impact-resistant cover can have a variety of dimensions. The cover can have a thickness of about 0.8 mm, 1.0 mm, 1.3 mm, 1.5 mm, 1.6 mm, 20 gauge, 22 gauge, and 24 gauge. The cover has a surface area sufficiently large to cover at least most of the aperture it is used to cover, e.g., in the range of about 0.18 square meters to about 1.5 square meters.

The means for attaching the cover to the shutter can include a hinge mechanism, a rivet mechanism, a bolt and socket mechanism, a pin and ring mechanism, and a latch mechanism. The shutter system of the invention can also include at least one locking mechanism for locking the cover in the closed position. The locking mechanism can include, for example, a first ring secured to the cover, a second ring secured to at least one panel of the plurality of panels, and a pin for engaging both rings. The locking mechanism can also include a rivet mechanism, a pin and ring mechanism, a latch mechanism, and a bolt and socket mechanism. The at least one locking mechanism is preferably accessible only from the interior of the building.

Also within the invention is a shutter for an openable window mounted in a building wall separating the interior and the exterior of a building. The shutter includes (a) an impact-resistant panel (i) sized to cover at least most of the portion of the window facing the exterior of the building and (ii) including an aperture sized for a person to pass through; (b) a means for reversibly attaching the panel to the wall; (c) an impact-resistant cover for the aperture, the cover being of sufficient size to close at least most of the aperture and reversibly postionable between a closed position wherein most of the aperture is covered and an open position wherein most of the aperture is not covered; and (d) a means for attaching the cover to the panel.

The invention also features a kit for retrofitting a conventional multi-panel storm shutter. The kit includes a plurality of panels capable of being assembled into an impact-resistant shutter (i) sized to cover at least most of the portion of the window facing the exterior of the building and (ii) including an aperture sized for a person to pass through, and printed instructions for retrofitting the conventional shutter.

Unless otherwise defined, all technical terms used herein have the same meaning as commonly understood by one of ordinary skill in the art to which this invention belongs. Although devices and methods similar or equivalent to those described herein can be used in the practice or testing of the present invention, suitable devices and methods are described below. The particular embodiments discussed below are illustrative only and not intended to be limiting.

### BRIEF DESCRIPTION OF THE DRAWINGS

FIG. 1 is a perspective view of a shutter system mounted to the exterior of a building wall. The impact-resistant cover is shown in a closed and locked position.

FIG. 2 is a plan view from the interior of a building of a shutter system mounted to the exterior of a building wall. The impact-resistant cover is shown in a closed and locked position.

FIG. 3 is a plan view from the interior of a building of a shutter system mounted to the exterior of a building wall. The impact-resistant cover is shown in an open position. In this embodiment, the cover has been unlocked and swung downward towards the exterior portion of the building that is below the window.

FIG. 4 is a perspective view of a shutter system mounted to the exterior of a building wall.

FIG. 5 is a perspective view from the exterior of a building of a shutter for an openable window mounted in a building wall separating the interior and exterior of a building.

### DETAILED DESCRIPTION

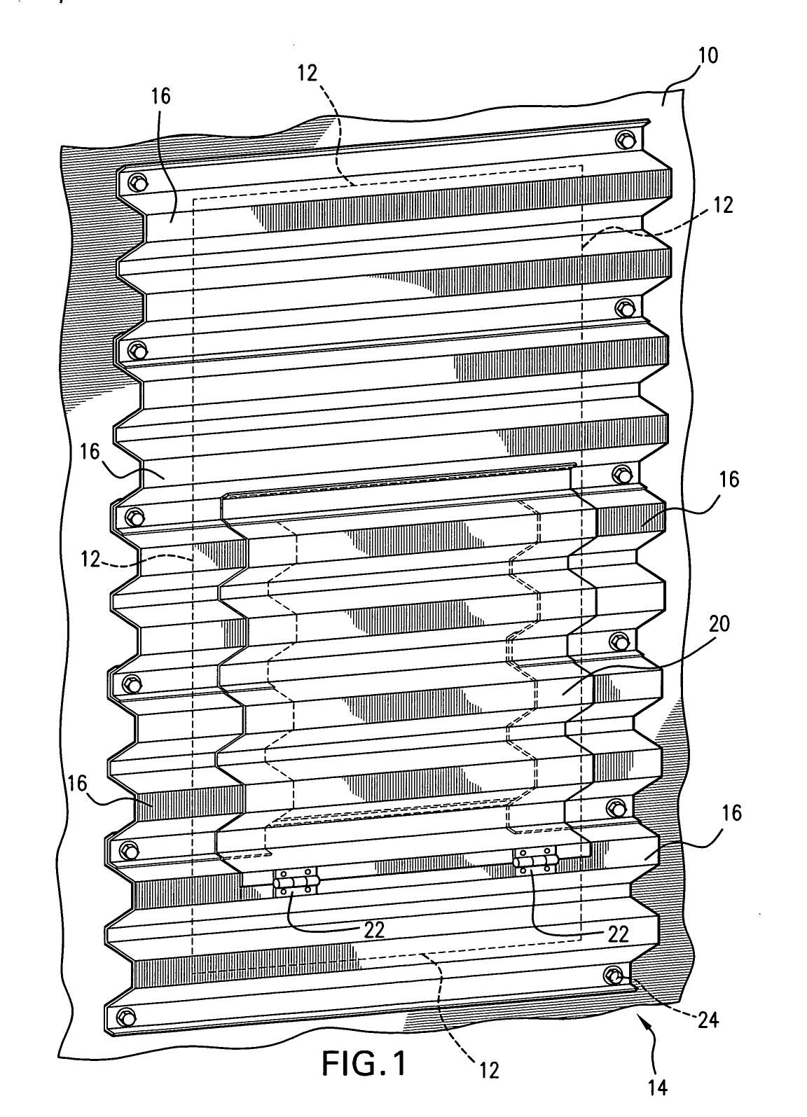

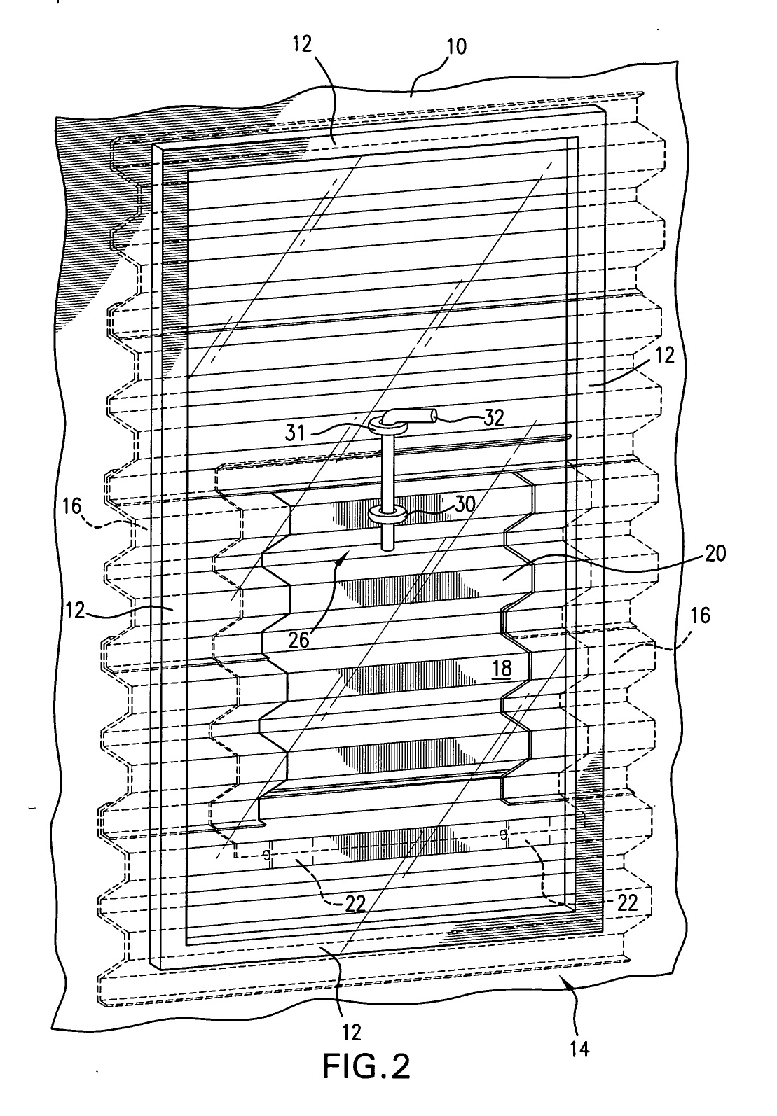

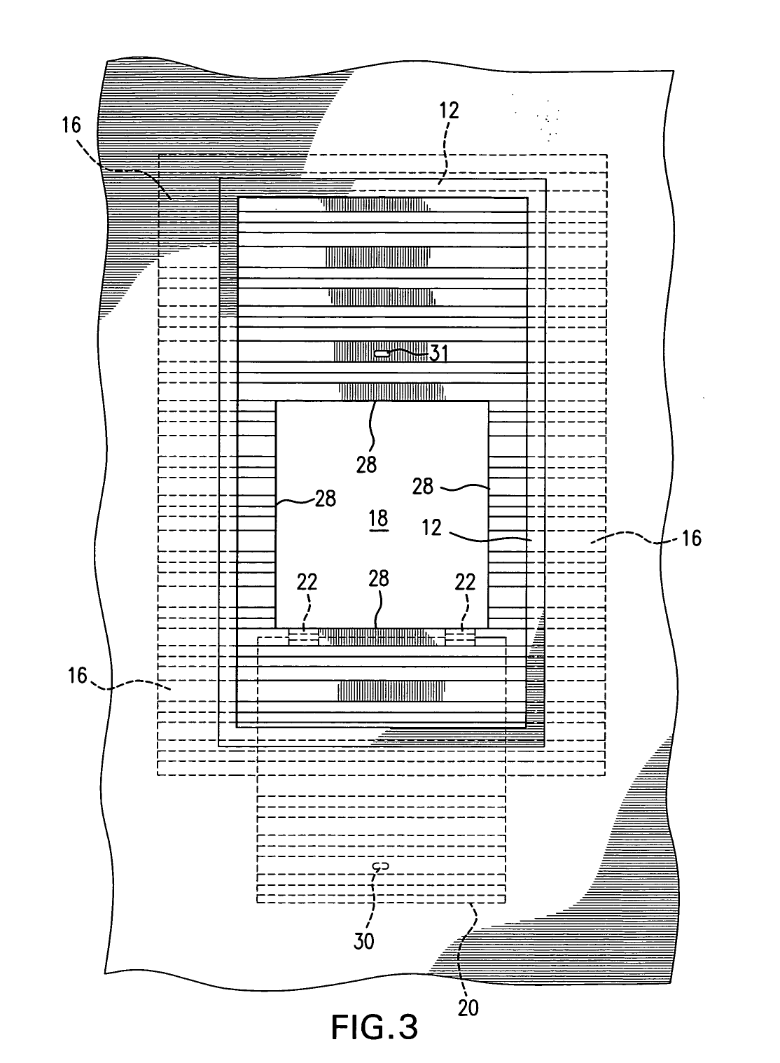

In brief overview, referring to FIG. 1, a first exemplary embodiment of a shutter system 14 of the present invention is shown mounted to the exterior of a building wall 10. A plurality of panels 16 are assembled into an impact-resistant shutter that is sized to cover at least most of the portion of the window 12 facing the exterior of the building and that has an aperture 18 sized for a person to pass through. The aperture 18 provides a means of egress during an emergency (e.g., fire) for a person within a building having the shutter system 14 installed. The shutter system 14 also includes a means 24 for reversibly attaching the plurality of panels 16 to the wall 10 (FIG. 1). A typical attachment means 24 includes a plurality of holes disposed along the perimeters of the panels 16 and bolts sized to fit through the holes. Any type of attachment means may be used, however, e.g., a rivet mechanism in which a metal pin is passed through holes in two or more pieces to hold them together, a clamp mechanism in which a device has opposite sides or parts that may be adjusted or brought closer together, a movable bar or rod that is slid into a socket, a screw mechanism in which a metal fastener having a tapered shank with a helical thread is driven into a building by rotating, as with a screwdriver, drill, etc. As shown in FIG. 1, the shutter system 14 further includes an impact-resistant cover 20 for the aperture 18. The cover 20 is of sufficient size to close at least most of the aperture 18. Referring to FIGS. 2 and 3, the cover 20 is shown reversibly positionable between a closed position (FIG. 2) wherein at least most of the aperture 18 is covered and an open position (FIG. 3) wherein at least most of the aperture 18 is not covered. Also shown in FIG. 1 is at least one means 22 for attaching the cover to the shutter.

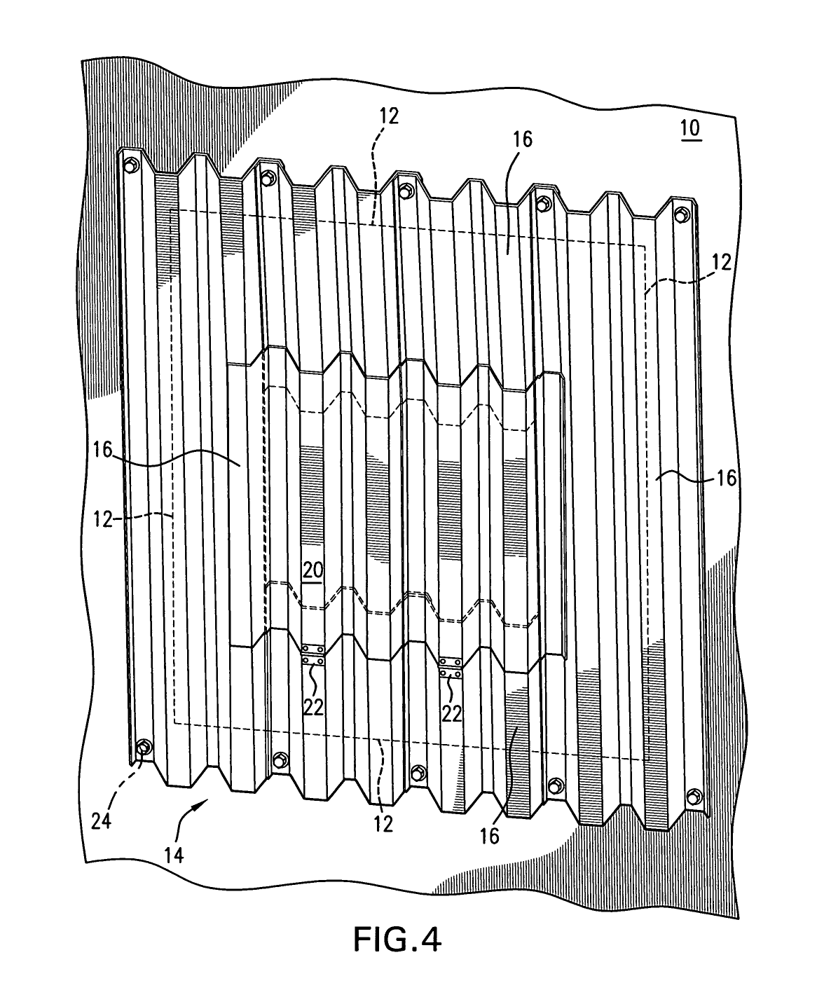

In the embodiment shown in FIG. 1, the panels 16 are corrugated (i.e., having a series of alternating ridges and furrows). When at least two panels 16 are placed to overlap one another, the ridges of one panel 16 overlap with the ridges of the other panel 16. Likewise, the furrows of one panel 16 overlap the furrows of the other panel 16. In other words, the panels are shaped to interlock with one another. The corrugated design is preferred because it allows for convenient and space-saving storage of the panels 16 when the shutter system 14 is not installed on a building and it also provides greater impact-resistance to the shutter system 14 when the panels 16 are attached to the building wall 10 in an overlapping position. The panels 16 of the shutter system 14 can be attached to the building wall 10 in a vertical orientation (FIG. 4) or a horizontal orientation (FIGS. 1-3). Whether the panels 16 are attached to the building in a vertical or horizontal orientation, the panels 16 are attached in an overlapping manner in preferred embodiments of the invention.

The panels 16 of the shutter system 14 are typically rectangular but can be of any suitable shape. To provide impact resistance, panels 16 are preferably made of a rigid material such as metal, wood, plastic, or an impact-resistant polymer. Materials such as aluminum, aluminum alloy, polycarbonate, polyvinyl chloride, and steel (e.g., galvanized steel) are particularly preferred. In some embodiments, the panels 16 can be translucent or transparent for letting light into the building as well as providing visibility of the exterior of the building.

The dimensions of the panels 16 can vary considerably. For example, the width of each panel 16 might range from about 0.1 to about 1.0 m (e.g., 0.09, 0.1, 0.2, 0.3, 0.33, 0.36, 0.4, 0.5, 0.6, 0.7, 0.8, 0.9, 1.0, 1.1 m). The height of the panels 16 might range from about 0.5 to about 10 m (e.g., 0.45, 0.5, 0.6, 0.7, 0.8, 0.9, 1.0, 1.1, 1.2, 1.3, 1.4, 1.5, 1.6, 1.7, 1.8, 1.9. 2.0, 2,1, 2.2, 2.3, 2.4, 2.5, 2.6, 2.7, 2.8, 2.9, 3.0, 3.1, 3.2, 3.3, 3.4, 3.5, 3.6, 3.7, 3.81, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0, 10.1 m); and the thickness of the panels 16 should be sufficient to impart impact resistance to the shutter system 14. The thickness of the panels 16 can vary but should preferably be sufficiently strong so as to sustain high-velocity winds, such as those of about 235 kilometers per hour (e.g., hurricane force winds). For instance, the panels 16 might have a thickness of 0.8 mm, 1.0 mm, 1.3 mm, 1.5 mm, 1.6 mm, 20 gauge, 22 gauge, or 24 gauge, e.g., 0.5 mm to 10 cm or 20 to 24 gauge.

The aperture 18 of the shutter system 14 can have a range of dimensions but should preferably be sized for most persons to fit through (e.g., in an emergency such as a house fire). In preferred embodiments the aperture 18 has a surface area in the range of about 0.18 square meters to about 1.5 square meters (e.g., 0.16, 0.17, 0.18, 0.19, 0.2, 0.3, 0.4, 0.5, 0.6, 0.7, 0.8, 0.9, 1.0, 1.1, 1.2, 1.3, 1.4, 1.5, 1.6, 1.7, etc.). As shown in FIG. 3, an aperture 18 of the shutter system 14 has an edge 28. In preferred embodiments, the edge 28 is substantially blunt (i.e., not sharp) so that a person passing through the aperture 18 is not injured. To further insure comfort and safety to a person passing through the aperture 18, the edge 28 of the aperture 18 can have a covering. The covering can be made of any material that is able to provide a non-sharp edge (e.g., rubber, plastic, fabric, and metal). When the shutter system 14 is mounted to a building wall 10, the aperture 18 is preferably positioned such that the window 12 is openable when the shutter system 14 is positioned over the window.

As shown in FIG. 1, the shutter system 14 includes a means 24 for reversibly attaching the plurality of panels 16 to the wall 10. In a preferred embodiment, the means 24 includes a plurality of holes positioned on at least one side of each panel 16 and a plurality of bolts for mating with the holes. When the bolts are driven through the plurality of holes in the panels 16 and then through the building wall 10 (e.g., screwed or nailed into the holes and into the wall 10 via electrical tools or manually), the shutter system 14 can be securely attached to the building wall 10. Any means capable of securely and reversibly attaching the panels 16 to the wall 10 can be used, e.g., a rivet mechanism in which a metal pin is passed through holes in two or more pieces to hold them together, a clamp mechanism in which a device has opposite sides or parts that may be adjusted or brought closer together, a movable bar or rod that is slid into a socket, a screw mechanism in which a metal fastener having a tapered shank with a helical thread is driven into a building by rotating, as with a screwdriver, drill, etc.

As illustrated in FIGS. 1-4, the shutter system 14 of the invention includes an impact-resistant cover 20 for the aperture 18. The impact-resistant cover 20 is sized to cover at least most of (preferably all of) the aperture 18 and is reversibly positionable between a closed position and an open position. During a storm, the impact-resistant cover is locked in a closed position wherein at least most of the aperture is covered (FIG. 2). In the embodiment shown in FIG. 2, the cover 20 is larger than the aperture 20, and the aperture 20 is therefore entirely covered by the cover 20. In other embodiments, however, the cover 20 may be sized equivalent to the aperture 20, or the cover 20 may be smaller than the aperture 18. To let in light, provide visibility to the exterior of the building, or exit the building during an emergency, the impact-resistant cover 20 is unlocked and positioned in an open position (FIG. 3). The impact-resistant cover 20 can be made of any material suitable for resisting sustained winds of about 235 kilometers per hour (e.g., hurricane force winds). Suitable materials include metal, wood, plastic, and impact-resistant polymer. Materials such as aluminum, aluminum alloy, polycarbonate, polyvinyl chloride, and steel (e.g., galvanized steel) are particularly preferred. The impact-resistant cover 20 can be translucent or transparent for letting light into the building as well as providing visibility to the exterior of the building. In preferred embodiments, the impact-resistant cover 20 and the plurality of panels 16 are made from the same material.

The impact-resistant cover 20 can be any shape as long as it covers at least most of the aperture 18 of the shutter system 14. For example, the impact-resistant cover 20 can be a square, rectangle, polygon, ellipse, oval, or circle. The impact-resistant cover 20 can be a single piece design (as described above, FIGS. 1-4) or it can be a multi-piece design. An impact-resistant cover having a multi-piece design might include two panels that abut each other along one axis and that cover the aperture 18 when the two panels are in a closed position. In this configuration, the two panels are each attached to the shutter by a means for attaching as described above (e.g., latch, hinge, clamp, etc.). When in an open position, the two panels are reversibly positioned in opposite directions (e.g., swung laterally) so that they no longer abut one another, thereby providing access to the aperture 18.

The impact-resistant cover 20 of the shutter system 14 can have a range of dimensions but should be sized according to the size of aperture 18. The thickness of the impact-resistant cover 20 should be sufficient to impart impact resistance to the shutter system 14. The thickness of the impact-resistant cover 20 can vary but should preferably be sufficiently strong so as to sustain high-velocity winds. For instance, the impact-resistant cover might have a thickness of 0.8 mm, 1.0 mm, 1.3 mm, 1.5 mm, 1.6 mm, 20 gauge, 22 gauge, or 24 gauge, e.g., 0.5 mm to 10 cm or 20 to 24 gauge

As shown in FIG. 2, the shutter system 14 further includes at least one means 22 for attaching the impact-resistant cover 20 to the shutter. In a preferred embodiment, the means 22 includes a hinge mechanism. The means 22, however, can be any structure or mechanism that securely attaches the cover 20 to the shutter. Examples of additional means 22 for attaching the impact-resistant cover 20 to the shutter include a rivet mechanism in which a metal pin is passed through holes in two or more pieces to hold them together, a clamp mechanism in which a device has opposite sides or parts that may be adjusted or brought closer together, a movable bar or rod that is slid into a socket, a screw mechanism in which a metal fastener having a tapered shank with a helical thread is driven into a building by rotating, as with a screwdriver, drill, etc.

FIG. 2 also illustrates another feature of the shutter system 14 of the invention, an at least one locking mechanism 26 for locking the impact-resistant cover 20 in the closed position. The locking mechanism 26 shown in FIG. 2 includes a first ring 30 secured to the impact resistant cover 20, a second ring 31 secured to at least one panel 16 of the plurality of panels, and a pin 32 for engaging both rings. In addition to the locking mechanism 26 illustrated in FIG. 2, any number of other locking mechanisms may be used for locking the impact-resistant cover 20 in the closed position. Examples of other locking mechanisms include a rivet mechanism in which a metal pin is passed through holes in two or more pieces to hold them together, a clamp mechanism in which a device has opposite sides or parts that may be adjusted or brought closer together, a movable bar or rod that is slid into a socket, a screw mechanism in which a metal fastener having a tapered shank with a helical thread is driven into a building by rotating, as with a screwdriver, drill, etc. In preferred embodiments, the at least one locking mechanism 26 is accessible only from the interior of the building. By having the at least one locking mechanism 26 accessible only from the interior of the building, storm forces such as winds are less likely to unlock the locking mechanism 26 and people on the exterior of the building, such as thieves and vandals, are precluded from unlocking the locking mechanism 26 and thereby gaining access to the interior of the building.

Also within the invention are kits composed of (a) a plurality of panels 16 capable of being assembled into an impact-resistant shutter sized to cover at least most of the portion of the window facing the exterior of the building and including an aperture 18 sized for a person to pass through, and (b) printed instructions for retrofitting the conventional shutter. A kit of the invention is particularly useful for replacing conventional panels (e.g., aluminum or steel shutters not having a means of egress) that may already exist for use on a particular building. To retrofit a plurality of conventional panels for a particular window, one or more of the conventional panels is replaced with one or more panels 16 of the invention having an aperture 18 and an impact-resistant cover 20. For example, it may only be necessary to replace two conventional panels (for protecting a particular window) with two panels 16 of the invention, the panels 16 of the invention having an aperture 18 and an impact-resistant cover 20. In this example, the panels 16 of the invention are installed to overlap with the conventional panels. Once the panels are installed, the window is entirely covered by panels (i.e., conventional panels and panels 16 of the invention) that provide protection from a storm as well as a means of egress for a person inside the building. To allow use with windows of all sizes, kits of the invention feature a variety of sizes and types of shutter systems 14. A kit of the invention can include several shutter systems 14, each sized for a particular window in a building (e.g., residence). A kit of the invention can alternatively include a single shutter system 14 of the invention.

An overview of the operation of the foregoing embodiments refers to FIGS. 1-3 in which a shutter system 14 having panels 16 is attached to a home in preparation for a storm. Typically, each panel 16 of the plurality of panels is reversibly attached to the exterior of a building (e.g., house) wall 10 using a plurality of bolts. The bolts are driven (e.g., screwed, nailed) through the plurality of holes in the panels 16 and into corresponding holes in the building wall 10. Various methods of attaching the plurality of panels 16 to the wall 10 can be substituted for the bolt and hole arrangement illustrated in FIG. 1. For example, a rivet mechanism in which a metal pin is passed through holes in two or more pieces to hold them together, a clamp mechanism in which a device has opposite sides or parts that may be adjusted or brought closer together, a movable bar or rod that is slid into a socket, or a screw mechanism in which a metal fastener having a tapered shank with a helical thread is driven into a building by rotating, as with a screwdriver or drill, can be used.

The plurality of panels 16 are assembled into an impact-resistant shutter having an aperture 18 and are attached to the building wall 10. the impact-resistant cover 20 is attached to the shutter via means 22. After attachment to the shutter, the impact-resistant cover 20 can be locked in a closed position from the interior of the building via at least one locking mechanism 26, e.g., a pin and pair of rings as shown in FIG. 2. Although only one locking mechanism 26 is shown in FIG. 2, two or more locking mechanisms 26 can be used per window (i.e., per shutter system). For example, a locking mechanism 26 can be disposed on each panel 16 of the shutter system 14. As another example, two or more locking mechanisms 26 can be disposed on a single panel 16.

To exit the building through the aperture 18 of the installed shutter system 14 in the event of an emergency (e.g., a fire), a person inside the building first either opens or breaks the window 12 to gain access to the shutter system 14. The person then unlocks the locking mechanism 26 and opens the impact-resistant cover 20, thereby gaining access to the aperture 18. The person then passes through the aperture 18 to the exterior of the building.

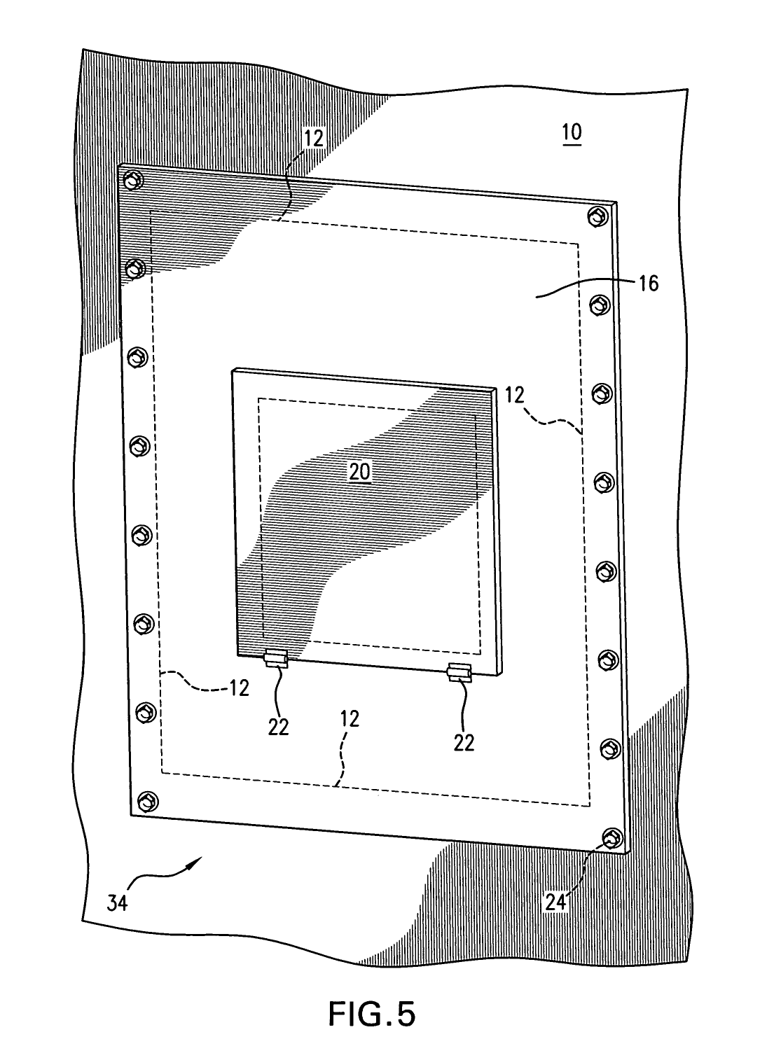

Another exemplary embodiment of the invention is shown in FIG. 5. A shutter 34 for an openable window mounted in a building wall separating the interior and exterior of a building includes (a) an impact-resistant panel 16 sized to cover at least most of the portion of the window facing the exterior of the building and including an aperture 18 sized for a person to pass through; (b) a means 24 for reversibly attaching the panel to the wall; (c) an impact-resistant cover 20 for the aperture 18, the cover 20 being of sufficient size to close at least most of the aperture 18 and reversibly positionable between a closed position wherein most of the aperture 18 is covered and an open position wherein most of the aperture 18 is not covered; and (d) a means for attaching the cover 20 to the panel 16. The shutter 34 can be used to cover nearly any shape and size of window. It is installed in a manner similar to the shutter system 14 described above. Rather than having a plurality of panels 16, the shutter 34 has a single impact-resistant panel 16. The shutter 34 is particularly useful for small and irregularly shaped windows.

From the foregoing, it can be appreciated that the shutter system of the invention provides a means for protecting a building (e.g., house) and its windows from adverse weather conditions while not blocking efficient egress from the home during emergencies. While the above specification contains many specifics, these should not be construed as limitations on the scope of the invention, but rather as examples of preferred embodiments thereof. Many other variations are possible. Accordingly, the scope of the invention should be determined not by the embodiments illustrated, but by the appended claims and their legal equivalents.

What is claimed is:

1. A shutter system for an openable window mounted in a building wall separating the interior and exterior of a building, the system comprising:
(a) a plurality of panels capable of being assembled into an impact-resistant shutter (i) sized to cover at least most of the portion of the window facing the exterior of the building and (ii) comprising an aperture sized for a person to pass through, and
(b) a means for reversibly attaching the plurality of panels to the wall,
(c) an impact-resistant cover for the aperture, the cover being of sufficient size to close at least most of the aperture and reversibly postionable between a closed position wherein at least most of the aperture is covered and an open position wherein most of the aperture is not covered, and
(d) at least one means for attaching the cover to the shutter.

2. The shutter system of claim 1, wherein the plurality of panels are made of a material selected from the group consisting of: metal, wood, plastic, and impact-resistant polymer.

3. The shutter system of claim 1, wherein the plurality of panels are translucent.

4. The shutter system of claim 1, wherein the plurality of panels are transparent.

5. The shutter system of claim 1, wherein the shutter is capable of resisting sustained winds in the range of about 60 kilometers per hour to about 240 kilometers per hour.

6. The shutter system of claim 1, wherein the width of each panel of the plurality of panels is selected from the group consisting of: 0.3 meters, 0.33 meters, and 0.36 meters.

7. The shutter system of claim 1, wherein the height of each panel of the plurality of panels is in the range of about 1 meter to about 3.81 meters.

8. The shutter system of claim 1, wherein the thickness of each panel of the plurality of panels is selected from the group consisting of: 0.8 millimeters, 1 millimeter, 1.3 millimeters, 1.5 millimeters, 1.6 millimeters, 20 gauge, 22 gauge, and 24 gauge.

9. The shutter system of claim 1, wherein the aperture has a substantially blunt edge.

10. The shutter system of claim 9, further comprising a covering disposed on the edge for providing an aperture free of sharp edges, the covering made of a material selected from the group consisting of: rubber, plastic, fabric, and metal.

11. The shutter system of claim 1, further comprising a means for reversibly attaching the plurality of panels to the wall.

12. The shutter system of claim 1, wherein the impact-resistant cover is made of a material selected from the group consisting of: metal, wood, plastic, and impact-resistant polymer.

13. The shutter system of claim 12, wherein the impact-resistant cover and the plurality of panels are made from the same material.

14. The shutter system of claim 1, wherein the impact-resistant cover is translucent.

15. The shutter system of claim 1, wherein the impact-resistant cover is transparent.

16. The shutter system of claim 1, wherein the thickness of the impact-resistant cover is selected from the group consisting of: 0.8 millimeters, 1.0 millimeters, 1.3 millimeters, 1.5 millimeters, 1.6 millimeters, 20 gauge, 22 gauge, and 24 gauge.

17. The shutter system of claim 1, further comprising at least one locking mechanism for locking the cover in the closed position.

18. The shutter system of claim 17, wherein the at least one locking mechanism is selected from the group consisting of: a rivet mechanism, a latch mechanism, a bolt and socket mechanism, and a pin and ring mechanism.

19. A shutter for an openable window mounted in a building wall separating the interior and exterior of a building, the shutter comprising:
(a) an impact-resistant panel (i) sized to cover at least most of the portion of the window facing the exterior of the building and (ii) comprising an aperture sized for a person to pass through;
(b) a means for reversibly attaching the panel to the wall;
(c) an impact-resistant cover for the aperture, the cover being of sufficient size to close at least most of the aperture and reversibly postionable between a closed position wherein most of the aperture is covered and an open position wherein most of the aperture is not covered; and
(d) a means for attaching the cover to the panel.

20. A kit for retrofitting a conventional multi-panel storm shutter, the kit comprising a plurality of panels capable of being assembled into an impact-resistant shutter (i) sized to cover at least most of the portion of the window facing the exterior of the building and (ii) comprising an aperture sized for a person to pass through,
and printed instructions for retrofitting the conventional shutter.
